(19) United States
(12) Patent Application Publication
(10) Pub. No.: US 2019/0318118 A1
(43) Pub. Date: Oct. 17, 2019

(54) SECURE ENCRYPTED DOCUMENT RETRIEVAL

(71) Applicant: International Business Machines Corporation, Armonk, NY (US)

(72) Inventors: Krishnasuri Narayanam, Bangalore (IN); Manish Kesarwani, Bangalore (IN); Sameep Mehta, New Delhi (IN)

(21) Appl. No.: 15/954,369

(22) Filed: Apr. 16, 2018

(51) Int. Cl. G06F 21/62

(52) U.S. Cl. CPC G06F 21/6227; G06F 2221/2115

(57) ABSTRACT

One embodiment provides a method, including: receiving, at a third-party storage provider, (i) a plurality of encrypted documents and (ii) a plurality of encrypted vectors corresponding to the plurality of encrypted documents; receiving a request to search the plurality of encrypted documents using an encrypted query vector; identifying whether at least one encrypted document from the encrypted documents is determined to be similar to the plaintext document provided in the received request, wherein the determining a similarity comprises communicating, between the third-party storage provider and at least another third-party storage provider without communicating components that would allow the other third-party storage provider to derive information regarding the documents; and returning a plaintext version of a returned encrypted document determined to be similar to the plaintext document provided in the received request.

### BACKGROUND

Digital data are created and stored at many different enterprises. Storing and managing data require physical storage space to store the data. Additionally, the storage and management of the data require software to organize, access, and otherwise manage the data. Typically, it is the data owner, the enterprise that is capturing and/or storing the data, who is responsible for the storage and management of the data. However, the storage and management of the data can be very expensive. Additionally, the costs increase as the volume of data that needs to be stored and managed increases.

Thus, many data owners may outsource the storage and management of data to a third party, for example, a third-party database service provider, also referred to as, a third-party storage provider. The third-party storage provider may also provide analytics in addition to the storage of data. Many of these third-party database service providers are cloud service providers that are accessible over an Internet connection. Such a model allows both client devices and the data owner to access the data in the third-party database service provider. This model eliminates the need for the data owner to purchase and manage expensive hardware and software to store and manage the data.

### BRIEF SUMMARY

In summary, one aspect of the invention provides a method, comprising: receiving, at a third-party storage provider, (i) a plurality of encrypted documents and (ii) a plurality of encrypted vectors corresponding to the plurality of encrypted documents, such that each one of the encrypted documents corresponds to at least one of the encrypted vectors, wherein a data owner has computed document vectors, representing identifiers of text terms, from plaintext versions of the encrypted documents and then encrypted both (i) the plurality of documents, thereby creating the encrypted documents and (ii) the plurality of document vectors, thereby creating the encrypted vectors; receiving, from a user, a request to search the encrypted documents using an encrypted query vector generated from a plaintext document provided in the received request; identifying whether at least one encrypted document from the encrypted documents is determined to be similar to the plaintext document provided in the received request, wherein the determining a similarity comprises communicating, between the third-party storage provider and at least another third-party storage provider, components to compute a similarity of the encrypted query vector to the encrypted vectors without communicating components that would allow the other third-party storage provider to derive information regarding the plaintext version of the encrypted documents; and returning, to the user, a plaintext version of a returned encrypted document determined to be similar to the plaintext document provided in the received request, wherein the data owner has decrypted the returned encrypted document.

Another aspect of the invention provides an apparatus, comprising: at least one processor; and a computer readable storage medium having computer readable program code embodied therewith and executable by the at least one processor, the computer readable program code comprising: computer readable program code configured to receive, at a third-party storage provider, (i) a plurality of encrypted documents and (ii) a plurality of encrypted vectors corresponding to the plurality of encrypted documents, such that each one of the encrypted documents corresponds to at least one of the encrypted vectors, wherein a data owner has computed document vectors, representing identifiers of text terms, from plaintext versions of the encrypted documents and then encrypted both (i) the plurality of documents, thereby creating the encrypted documents and (ii) the plurality of document vectors, thereby creating the encrypted vectors; computer readable program code configured to receive, from a user, a request to search the encrypted documents using an encrypted query vector generated from a plaintext document provided in the received request; computer readable program code configured to identify whether at least one encrypted document from the encrypted documents is determined to be similar to the plaintext document provided in the received request, wherein the determining a similarity comprises communicating, between the third-party storage provider and at least another third-party storage provider, components to compute a similarity of the encrypted query vector to the encrypted vectors without communicating components that would allow the other third-party storage provider to derive information regarding the plaintext version of the encrypted documents; and computer readable program code configured to return, to the user, a plaintext version of a returned encrypted document determined to be similar to the plaintext document provided in the received request, wherein the data owner has decrypted the returned encrypted document.

An additional aspect of the invention provides a computer program product, comprising: a computer readable storage medium having computer readable program code embodied therewith, the computer readable program code executable by a processor and comprising: computer readable program code configured to receive, at a third-party storage provider, (i) a plurality of encrypted documents and (ii) a plurality of encrypted vectors corresponding to the plurality of encrypted documents, such that each one of the encrypted documents corresponds to at least one of the encrypted vectors, wherein a data owner has computed document vectors, representing identifiers of text terms, from plaintext versions of the encrypted documents and then encrypted both (i) the plurality of documents, thereby creating the encrypted documents and (ii) the plurality of document vectors, thereby creating the encrypted vectors; computer readable program code configured to receive, from a user, a request to search the encrypted documents using an encrypted query vector generated from a plaintext document provided in the received request; computer readable program code configured to identify whether at least one encrypted document from the encrypted documents is determined to be similar to the plaintext document provided in the received request, wherein the determining a similarity comprises communicating, between the third-party storage provider and at least another third-party storage provider, components to compute a similarity of the encrypted query vector to the encrypted vectors without communicating components that would allow the other third-party storage provider to derive information regarding the plaintext version of the encrypted documents; and computer readable program code configured to return, to the user, a plaintext version of a returned encrypted document determined to be similar to the plaintext document provided in the received request, wherein the data owner has decrypted the returned encrypted document.

A further aspect of the invention provides a method, comprising: receiving an encrypted query vector, wherein a data owner generated the encrypted query vector from a query provided by a user, the query comprising a request to find at least one document from a plurality of documents having a similarity to a plaintext document included in the query; the plurality of documents being stored at a third-party storage provider as a plurality of encrypted documents having corresponding encrypted vectors, wherein a data owner has, before storage at the third-party storage provider, encrypted (i) the plurality of documents and (ii) corresponding document vectors in which identifiers of text terms of the corresponding document are represented; identifying at least one encrypted document having a determined similarity to the received at least one encrypted query vector, wherein the identifying comprises communicating between the third-party storage provider and at least another third-party storage provider, wherein the third-party storage provider and the at least another third-party storage provider do not collude; the communicating allowing for (i) computation of a similarity between the received at least one encrypted query vector and at least one of the encrypted vectors and (ii) maintaining the encryption security of the plurality of encrypted documents and corresponding encrypted vectors from the third-party storage provider; and returning, to the user, a plaintext version of the identified at least one encrypted document, wherein the at least one encrypted document has been decrypted by an agent other than an agent of the third-party storage provider.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of retrieving encrypted documents from a third-party storage provider without revealing information regarding the documents to the third-party storage provider.

FIG. 2 illustrates an example communication flow between a data owner, security agent, and third-party storage providers that maintains the security of encrypted documents.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

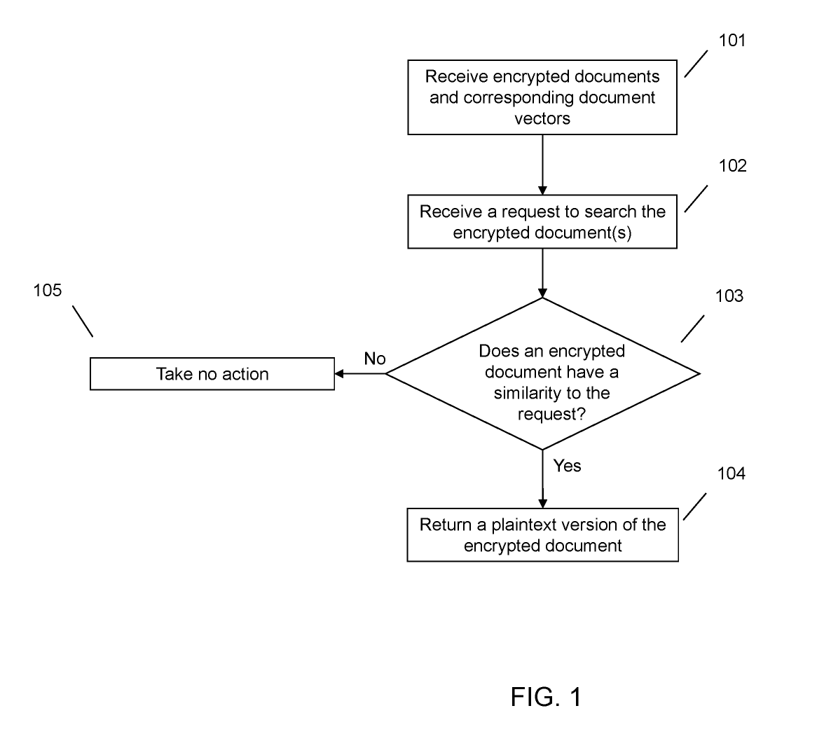

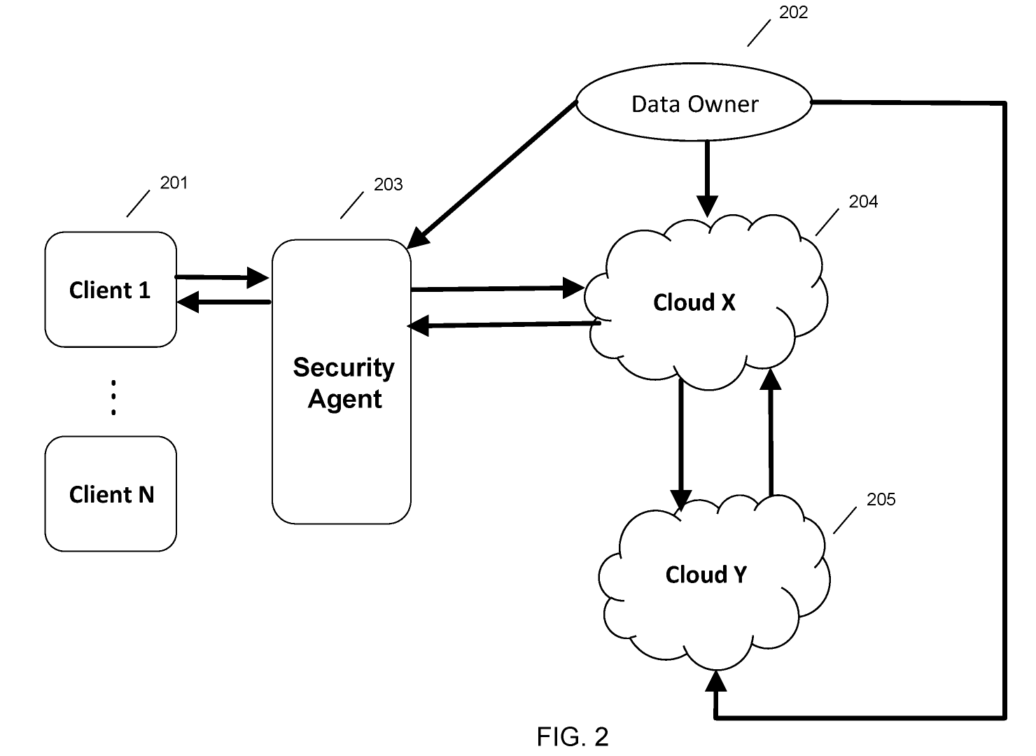

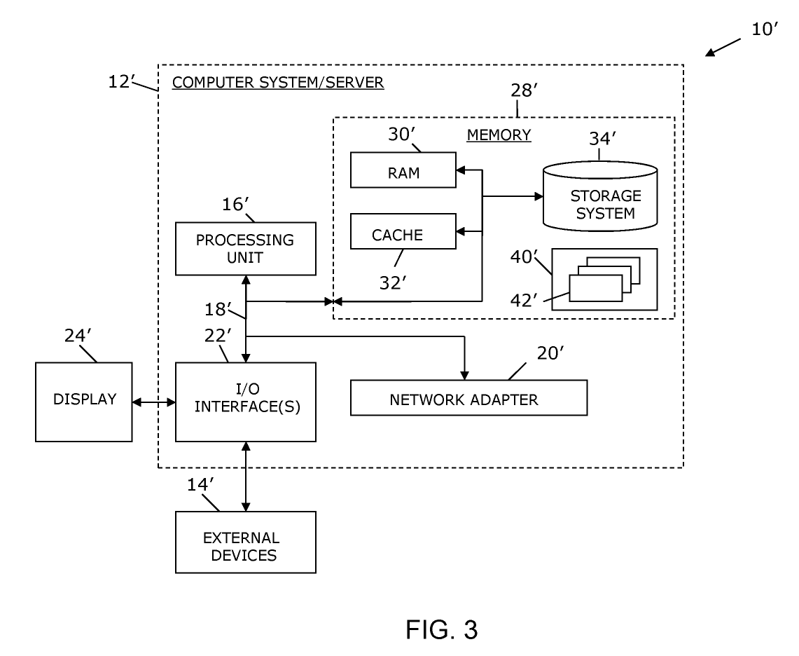

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

Third-party database service providers are very useful and helpful to data owners. Rather than having to store and manage data, the data owner can simply transfer the data to the third-party. Since the third-party is generally accessible over the Internet, both the data owner and client devices can access the data. Therefore, the third-party database service provider provides an efficient, cost-effective, and scalable data storage and management solution to data owners. However, a problem with storing data at a third-party storage provider is that the data owner loses control over the data. Rather than maintaining the data on-site, the data owner is now shipping the data to a database service provider. In other words, the data owner cannot ensure that the data are secure. Specifically, the third-party storage system may attempt to learn information regarding the data. In other words, the database service provider is also curious about the data and may misuse the data for purposes other than merely storing the data.

One solution is to encrypt the data before the data are stored at the third-party. In other words, before the data owner transfers the data to the third-party, the data owner encrypts the data using a standard encryption scheme, for example, using Advanced Encryption Standard (AES) or any other encryption protocol. However, this still does not ensure that the third-party storage provider will not learn information regarding the encrypted data. For example, when the provider receives a query to find a similar document or phrase the system may use a cosine similarity technique to return a result. However, this reveals information regarding the frequency of the occurrence of words within the document to the service provider. Additionally, since the documents are encrypted, synonyms with regards to the query terms cannot be handled by the system. Additionally, a cosine similarity technique cannot be used or applied if the encryption is non-deterministic, meaning the same words do not produce the same ciphertext every time the word is encrypted, particularly over separate executions of the encryption algorithm. Specifically, if the word is not the same every time it is encrypted, the system cannot identify which encrypted words are the same words.

Accordingly, the techniques and systems as described herein provide a system and technique for retrieving encrypted documents from a third-party storage provider without revealing information regarding the documents to the third-party storage provider. For example, using the systems and methods described herein third-party storage providers are unable to learn enough information regarding the encrypted documents that would allow either provider to break the encryption, learn a frequency of occurrences of words within the encrypted documents, or even learn or know the computed cosine similarity value between a query and any of the encrypted documents. A data owner may have a plurality of documents that the data owner desires to store at a third-party storage provider. The data owner generates document vectors, for use in a cosine similarity technique, for each of the documents and then encrypts the documents and the corresponding document vectors. The data owner transmits the encrypted documents to a third-party storage provider. The data owner also transmits public/private key pairs to a different third-party storage provider.

When the system receives a request to find a document having a similarity to an encrypted document, the system encrypts the query vectors using the same encryption protocol that was used to encrypt the original documents. The encrypted document vector is then transmitted to the third-party storage provider for querying the encrypted documents. However, since the encrypted documents are stored at one third-party storage provider and the encryption key pairs are stored at a different third-party storage provider, the two third-party storage providers have to communicate with each other in order to compute the cosine similarity. In other words, neither third-party storage provider has enough information to compute the cosine similarity individually. The fact that neither third-party storage provider can compute the cosine similarity also means that neither third-party storage provider can derive information regarding the encrypted documents. Thus, the two third-party storage providers communicate different components of the cosine similarity computation and the documents, until it can be determined whether at least one encrypted document has a similarity to the requested document. The security agent then decrypts the document and returns a plaintext version of any returned document to the requesting individual.

Such a system provides a technical improvement over current systems for storing data at a third-party storage provider by allowing encrypted data to be stored at the third-party storage provider while preventing the third-party storage provider from learning information regarding the encrypted data. The systems and methods as described herein allow different third-party storage providers to know different components regarding the documents and the encryption technique used to encrypt the documents. The system allows communication between the different third-party storage providers in order to perform the desired operation, but does not provide enough information to any of the third-party storage providers that would allow any of the third-party storage providers to derive information regarding the encrypted documents. Thus, the systems and methods as described herein provide an encryption technique that allows for finding similar documents, words, or phrases using a cosine similarity technique that allows for handling of synonyms and allows for use with encryption techniques that may be non-deterministic. Additionally, neither of the third-party storage providers can learn enough information regarding the encrypted documents that would allow either provider to break the encryption, learn a frequency of occurrences of words within the encrypted documents, or even learn or know the computed cosine similarity value between the query and any of the encrypted documents. Thus, the described systems and methods provide for more secure data storage where the third-party storage provider cannot learn information regarding the encrypted documents.

FIG. 1 illustrates a method for retrieving encrypted documents from a third-party storage provider without revealing information regarding the documents to any of the third-party storage providers. At 101, a third-party storage provider receives a plurality of documents that are to be stored. The third-party storage provider may be a curious adversary who may attempt to use the data for some purpose other than storage and management of the data. In other words, the third-party storage provider may try to learn things from the data, even though the third-party storage provider is only supposed to store and manage the data, making it an adversary. However, the third-party storage provider provides valid answers to any queries, thereby making it an honest adversary. Thus, the systems and methods as described herein are intended to protect the data from the third-party storage provider, which may also be referred to herein as “third-party” for readability.

The documents may be received from a client of the data owner. The client may be a device or user requesting that the data owner store information for the client. In other words, the data owner may be storing information on behalf of the client. The client may also be a client of the data owner and the data may be information captured by the data owner during interactions with the client. In other words, the data owner may be the creator of the documents. Receiving the documents may include receiving or otherwise obtaining the data directly from the client, creating the data at the data owner, accessing the data from a data storage location, or the like.

The plurality of documents are received, at the data owner, as plaintext documents. Plaintext documents are the version of the document before the document is encrypted or otherwise manipulated for storage at the third-party storage provider. The data owner generates a plurality of document vectors corresponding to the plaintext version of the plurality of documents. A document vector is generated when using a similarity computation technique. The document vector is an algebraic vector that represents text documents as vectors of identifiers, for example, index terms, keywords, or the like. Thus, a document vector represents identifiers of text terms within the document. A cosine similarity technique uses term frequency-inverse document frequency to extract a set of distinct keywords and, using these extracted set of keywords, represents each document as a vector. If a word has a synonym, the synonym of the word is assigned to the same position in the vector. Since the document vector is created using the plaintext version of the document, the technique as described herein provides for allowance of synonyms with regards to computing the cosine similarity, even though the documents, when stored at the third-party storage provider, are encrypted.

The data owner then performs encryption of both the plurality of documents and the corresponding document vectors. It should be understood that the document vector encryption is performed separately from the encryption of the documents. In other words, the documents and the corresponding vectors are not encrypted together, but, rather, are encrypted as separate components. To perform the document encryption the data owner may use an encryption technique or standard, for example, Advanced Encryption Standard (AES) or any other encryption technique. The disclosure will refer to AES, but it should be understood that any other encryption technique that results in a secret key can be used. The data owner may use a separate encryption technique or standard to encrypt each component of the document vectors, for example, Boneh, Goh, and Nissim (BGN) encryption or any other encryption technique that allows limited additive and multiplicative homomorphism. The disclosure will refer to BGN encryption for ease of readability, but it should be understood that any encryption standard that allows for limited additive and multiplicative homomorphism or other applicable encryption standard or technique may be used. The BGN encryption produces a private/public key pair. Thus, the encryption of the document vector components may be performed using the public key of the BGN encryption. The data owner may also generate a public/private key pair using a third encryption technique or standard, for example, ElGamal encryption or any other encryption technique that has a multiplicative homomorphism property. The disclosure will refer to ElGamal encryption for ease of readability, but it should be understood that any encryption standard that allows for multiplicative homomorphism or any other applicable encryption technique may be used.

In order to reduce the management of the documents and encryption/decryption, the data owner may enlist a security agent. The security agent may be an intermediary between the data owner and/or third-party storage provider and the clients who may be requesting documents that are stored at the third-party storage provider. Once the data owner has created the document vectors and encrypted the documents and document vectors, the security agent may perform any additional encryption that is required, for example, encryption of a received query, as discussed in more detail below, and may also perform decryption of documents that are returned by the third-party storage provider. Thus, the data owner provides the security agent the secret key that was generated using the AES encryption and the BGN and ElGamal public/private key pairs. Additionally, the data owner transmits the BGN and ElGamal public/private key pairs to a third-party storage provider. The data owner does not transmit the AES secret key to the third-party storage provider. The third-party storage provider receiving the public/private keys will be referred to as the second third-party storage provider for ease of readability only. The terms “second” and “first” do not designate any temporal or numerical relationship between the different third-party storage providers. Additionally, these terms do not designate that only two third-party storage providers are used to implement the systems and methods described herein, as more than two third-party storage providers may be used.

The system may then transmit the plurality of encrypted documents and plurality of encrypted document vectors to a third-party storage provider, referred to as the first third-party storage provider for ease of readability only. This first third-party storage provider is a third-party storage provider that is separate from the second third-party storage provider that received the public/private key pairs. The third-party storage provider may include a federated system of cloud storage locations. Thus, a first third-party storage provider may include one cloud storage location of the federated system and the second third-party storage provider may include a different cloud storage location of the federated system. The cloud storage locations within the federated system can communicate with each other. However, the two third-party storage providers that are used within the described system cannot collude with each other. Colluding means that the two third-party storage providers would work together in order to break the encryption and derive information regarding the encrypted documents or the plaintext versions of the encrypted documents. Thus, the described system uses at least two third-party storage providers that do not work together in order to derive information regarding the encrypted documents or the plaintext versions of the encrypted documents. The third-party storage provider may include more than two non-colluding third-party storage providers, which can be used by the system. Additionally, the third-party storage provider may include colluding third-party storage providers. However, these colluding third-party storage providers will not be used by the described system for the portions of the system that are kept separate from the two third-party storage providers. In other words, the colluding third-party storage providers will be treated as sets and the system uses at least two sets of third-party storage providers where colluding can occur within the set but not outside the set.

At 102 the third party storage provider may receive a request from a user, for example, a client, the data owner, or the like. The received request may be transmitted to the third-party storage provider through an intermediary. The request may include a request to search the encrypted documents to determine if any of the encrypted documents have a similarity to a plaintext document (e.g., word, phrase, entire document, etc.) provided in the received request. In other words, a user can provide a query to find a word, phrase, or entire document that was previously encrypted and stored at the third-party storage provider. It should be understood that there may be no encrypted documents that match the request of the user. The document that is the subject of the query is a plaintext document since the user has no information regarding the encryption of the documents. However, the documents to be queried have been encrypted and sent to the third-party storage provider.

Accordingly, when the intermediary sends the received request to the third-party storage provider, the system may generate an encrypted query vector from the document associated with the query, referred to as the requested document. For example, the security agent (or data owner) may receive the requested document and generate one or more document vectors from the document using the same technique that was used to generate the document vectors for the documents sent to the third-party storage provider. The security agent (or data owner) may then encrypt the query vector using the same encryption protocol that was used to encrypt the document vectors, for example, using the same BGN public key that was used to encrypt the document vectors, before storage at the third-party storage provider. The encrypted query vector is then sent to the first third-party storage provider, which is the third-party storage provider that received the encrypted documents and corresponding encrypted vectors.

At 103 the system may determine whether one or more encrypted documents have a similarity to the requested document using the encrypted query vector. To determine whether one or more encrypted documents have a similarity, the third-party storage provider may compute a similarity of the encrypted query vector as compared with the encrypted documents using the encrypted document vectors. For ease of readability the computation of a similarity will refer to a computation of a cosine similarity. However, the systems and techniques as described herein may be applied to other similarity computations, for example, logarithmic similarity computation, clustering similarity computation, or other similarity computation algorithm.

The encrypted documents and encrypted document vectors are stored in one third-party storage provider, while the encryption public/private key pairs are stored in a different third-party storage provider. Additionally, neither third-party storage provider will share the known information with the other. However, the two third-party storage providers will communicate with each other in order to provide results that can be computed by the respective third-party storage provider. Thus, the two third-party storage providers work together to compute the cosine similarity and identify the encrypted documents that meet or exceed a particular similarity threshold. The second third-party storage provider may know the threshold for the similarity of the documents. Alternatively, the system, for example, the security agent, may receive a threshold value from the requesting client or may set a threshold value. The security agent, or other encrypting component, may encrypt the threshold value using one of the sets of public/private keys and then send this encrypted value to the second third-party storage provider. The second third-party storage provider may then decrypt this value using the respective key and use the decrypted value for comparison.

The computation for cosine similarity of an input vector A with each comparative document B may be represented as the following formula: Cosine-similarity(A,B)=(A·B)/(|A|₂|B|₂). Thus, for a plurality of documents the formula may be:

$$\frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

where Aᵢ and Bᵢ are components of vectors A and B, respectively. The first third-party storage provider can compute the individual components that are necessary for computing cosine similarity from the encrypted query vector. For example, the first third-party storage provider computes the individual components: Σᵢ₌₁ⁿAᵢBᵢ, Σᵢ₌₁ⁿAᵢ², and Σᵢ₌₁ⁿBᵢ². The first third-party storage provider then forwards these computed, and encrypted, individual components to the second third-party storage provider in a random order.

The second third-party storage provider decrypts each of the encrypted computed individual components. The second third-party storage provider then re-encrypts each component using the ElGamal public/private key pair that was provided by the data owner, resulting in encrypted ciphertexts. The second third-party storage provider then transmits the ElGamal encrypted ciphertexts back to the first third-party storage provider. The first third-party storage provider is now able to compute the squared cosine similarity using the ElGamal encrypted ciphertexts and is able to determine an encrypted cosine similarity to documents within the first third-party storage provider. The first third-party storage provider then sends the encrypted cosine similarity of the documents and anonymized document identifiers to the second third-party storage provider.

The second third-party storage provider decrypts the received ciphertexts using the public/private key pairs and matches the decrypted ciphertexts with the document identifiers to identify the document identifiers that correspond to the similar documents that meet or exceed a predetermined threshold. For example, the system may only return documents having a 90% similarity to the received query vector. The predetermined threshold can be any number and may be set by the user. If any documents have a similarity that meet or exceed the similarity threshold, the document identifiers that correspond to the documents meeting or exceeding the similarity threshold as identified by the second third-party storage provider are returned to the first third-party storage provider. The first third-party storage provider can then return the document having the identified document identifier to the system, for example, the data owner or security agent.

Thus, the system may receive from the third-party storage provider at least one encrypted document having a determined similarity to the requesting document, if any such documents exist. In order to determine whether a document meets the similarity threshold, the two third-party storage providers communicate different components to compute a cosine similarity of the received query to the plurality of encrypted documents or encrypted document vectors. However, neither third-party storage provider has enough information to derive information regarding the encrypted documents and/or plaintext version of the encrypted documents. Thus, the system ensures that no information regarding the frequency of occurrence of one or more words within the document is revealed and the system can be used even if the encryption is non-deterministic. Additionally, neither third-party storage provider knows or can determine the cosine similarity value of a specific document to the received query.

The system may determine that no encrypted documents have a similarity to the received query. Thus, if no encrypted documents have a similarity to the received query at 103, the system may take no action at 105. Alternatively, the system may indicate that no documents match the received query or that no documents match the received query within the predetermined similarity threshold. If, however, at least one encrypted document is returned from the third-party storage provider at 103, the system may provide an indication that a document has a determined similarity within the predetermined similarity threshold of the document of the request by returning a plaintext version of the document to the user at 104. The document returned from the third-party service provider is an encrypted document. Thus, when the encrypted document is returned either the security agent or the data owner can decrypt the document using the secret key that was used to encrypt the document before storage at the third-party storage provider.

FIG. 2 illustrates an overview of the communication between the components of the system. The data owner 202 stores the plurality of encrypted documents and corresponding document vectors at a first cloud-storage provider, Cloud X 204. The data owner 202 shares the encryption secret key that was generated and used to encrypt the documents, and the public/private keys, used to encrypt the document vectors, with the Security Agent 203. The data owner shares the public/private keys with a second cloud-storage provider, Cloud Y 205. The client(s) 201 provide a request to search for a document which is sent to the Security Agent 203. The request is encrypted by the Security Agent 203 and is sent to Cloud X 204. Cloud X 204 and Cloud Y 205 communicate different components to compute the cosine similarity to determine if any encrypted documents should be returned in response to the request provided by the client 201. If any documents have a determined similarity meeting or exceeding a threshold similarity, Cloud X 204 returns the encrypted document to the Security Agent 203. The Security Agent 203 decrypts the document(s) using the encryption secret key and returns the plaintext document to the requesting client(s) 201.

Thus, the described systems and methods provide a method for ensuring the security of documents stored at a third-party storage provider, including securing the documents from the third-party storage provider. Additionally, the systems and methods as described herein ensure that no information is revealed to the third-party storage provider that would allow the third-party storage provider to derive information regarding either the encrypted documents and/or the encrypted document vectors. For example, the third-party storage providers are unable to learn enough information regarding the encrypted documents that would allow either provider to break the encryption, learn a frequency of occurrences of words within the encrypted documents, or even learn or know the computed cosine similarity value between the query and any of the encrypted documents. Additionally, the systems and methods provide a technique where synonyms can be handled even though the documents are encrypted. Finally, the systems and methods as described herein also can be applied even if the encryption technique is non-deterministic.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
receiving, at a third-party storage provider, (i) a plurality of encrypted documents and (ii) a plurality of encrypted vectors corresponding to the plurality of encrypted documents, such that each one of the encrypted documents corresponds to at least one of the encrypted vectors, wherein a data owner has computed document vectors, representing identifiers of text terms, from plaintext versions of the encrypted documents and then encrypted both (i) the plurality of documents, thereby creating the encrypted documents and (ii) the plurality of document vectors, thereby creating the encrypted vectors;
receiving, from a user, a request to search the encrypted documents using an encrypted query vector generated from a plaintext document provided in the received request;
identifying whether at least one encrypted document from the encrypted documents is determined to be similar to the plaintext document provided in the received request, wherein the determining a similarity comprises communicating, between the third-party storage provider and at least another third-party storage provider, components to compute a similarity of the encrypted query vector to the encrypted vectors without communicating components that would allow the other third-party storage provider to derive information regarding the plaintext version of the encrypted documents; and
returning, to the user, a plaintext version of a returned encrypted document determined to be similar to the plaintext document provided in the received request, wherein the data owner has decrypted the returned encrypted document.

2. The method of claim 1, wherein the data owner has encrypted the plaintext versions of the documents using a secret key generated using a first encryption standard, wherein each component of the plurality of encrypted vectors is encrypted using a key of a public/private key pair generated using a second encryption standard, and wherein the data owner creates a public/private key pair using a third encryption standard.

3. The method of claim 2, wherein the public/private key pair generated using the second encryption standard and the public/private key pair generated using the third encryption standard are transmitted to the at least another third-party storage provider.

4. The method of claim 1, wherein the computing a similarity comprises computing a cosine similarity.

5. The method of claim 1, wherein the communicating comprises computing encrypted individual components for computing the similarity from the encrypted query vector and transmitting, in random order, the computed encrypted individual components to the at least another third-party storage provider.

6. The method of claim 5, wherein the communicating comprises receiving from the at least another third-party storage provider ciphertexts comprising re-encrypted components, wherein the at least another third-party storage provider generated the ciphertexts by decrypting and re-encrypting the transmitted computed encrypted individual components using at least one public/private key pair transmitted to the at least another third-party storage provider from the data owner.

7. The method of claim 6, wherein the communicating comprises (i) computing the similarity using the received ciphertexts and (ii) transmitting the computed similarity to the at least another third-party storage provider.

8. The method of claim 7, wherein the communicating comprises receiving, from the at least another third-party storage provider, document identifiers having a similarity to the encrypted query vector, wherein the at least another third-party storage provider identified the document identifiers by (i) decrypting, using the at least one public/private key pair, the transmitted computed similarity and (ii) identifying the document identifiers using the decrypted transmitted computed similarity.

9. The method of claim 1, wherein the generated encrypted query vector is encrypted using the same encryption protocol used to encrypt the plurality of document vectors.

10. The method of claim 1, wherein the determining similarity comprises determining a similarity meeting a predetermined threshold.

11. An apparatus, comprising:
at least one processor; and
a computer readable storage medium having computer readable program code embodied therewith and executable by the at least one processor, the computer readable program code comprising:
computer readable program code configured to receive, at a third-party storage provider, (i) a plurality of encrypted documents and (ii) a plurality of encrypted vectors corresponding to the plurality of encrypted documents, such that each one of the encrypted documents corresponds to at least one of the encrypted vectors, wherein a data owner has computed document vectors, representing identifiers of text terms, from plaintext versions of the encrypted documents and then encrypted both (i) the plurality of documents, thereby creating the encrypted documents and (ii) the plurality of document vectors, thereby creating the encrypted vectors;
computer readable program code configured to receive, from a user, a request to search the encrypted documents using an encrypted query vector generated from a plaintext document provided in the received request;
computer readable program code configured to identify whether at least one encrypted document from the encrypted documents is determined to be similar to the plaintext document provided in the received request, wherein the determining a similarity comprises communicating, between the third-party storage provider and at least another third-party storage provider, components to compute a similarity of the encrypted query vector to the encrypted vectors without communicating components that would allow the other third-party storage provider to derive information regarding the plaintext version of the encrypted documents; and
computer readable program code configured to return, to the user, a plaintext version of a returned encrypted document determined to be similar to the plaintext document provided in the received request, wherein the data owner has decrypted the returned encrypted document.

12. A computer program product, comprising:
a computer readable storage medium having computer readable program code embodied therewith, the computer readable program code executable by a processor and comprising:
computer readable program code configured to receive, at a third-party storage provider, (i) a plurality of encrypted documents and (ii) a plurality of encrypted vectors corresponding to the plurality of encrypted documents, such that each one of the encrypted documents corresponds to at least one of the encrypted vectors, wherein a data owner has computed document vectors, representing identifiers of text terms, from plaintext versions of the encrypted documents and then encrypted both (i) the plurality of documents, thereby creating the encrypted documents and (ii) the plurality of document vectors, thereby creating the encrypted vectors;
computer readable program code configured to receive, from a user, a request to search the encrypted documents using an encrypted query vector generated from a plaintext document provided in the received request;
computer readable program code configured to identify whether at least one encrypted document from the encrypted documents is determined to be similar to the plaintext document provided in the received request, wherein the determining a similarity comprises communicating, between the third-party storage provider and at least another third-party storage provider, components to compute a similarity of the encrypted query vector to the encrypted vectors without communicating components that would allow the other third-party storage provider to derive information regarding the plaintext version of the encrypted documents; and
computer readable program code configured to return, to the user, a plaintext version of a returned encrypted document determined to be similar to the plaintext document provided in the received request, wherein the data owner has decrypted the returned encrypted document.

13. The computer program product of claim 12, wherein the data owner has encrypted the plaintext versions of the documents using a secret key generated using a first encryption standard, wherein each component of the plurality of encrypted vectors is encrypted using a key of a public/private key pair generated using a second encryption standard, and wherein the data owner creates a public/private key pair using a third encryption standard.

14. The computer program product of claim 13, wherein the public/private key pair generated using the second encryption standard and the public/private key pair generated using the third encryption standard are transmitted to the at least another third-party storage provider.

15. The computer program product of claim 12, wherein the communicating comprises computing encrypted individual components for computing the similarity from the encrypted query vector and transmitting, in random order, the computed encrypted individual components to the at least another third-party storage provider.

16. The computer program product of claim 15, the communicating comprises receiving from the at least another third-party storage provider ciphertexts comprising re-encrypted components, wherein the at least another third-party storage provider generated the ciphertexts by decrypting and re-encrypting the transmitted computed encrypted individual components using at least one public/private key pair transmitted to the at least another third-party storage provider from the data owner.

17. The computer program product of claim 16, wherein the communicating comprises (i) computing the similarity using the received ciphertexts and (ii) transmitting the computed similarity to the at least another third-party storage provider.

18. The computer program product of claim 17, wherein the communicating comprises receiving, from the at least another third-party storage provider, document identifiers having a similarity to the encrypted query vector, wherein the at least another third-party storage provider identified the document identifiers by (i) decrypting, using the at least one public/private key pair, the transmitted computed similarity and (ii) identifying the document identifiers using the decrypted transmitted computed similarity.

19. The computer program product of claim 12, wherein the generated encrypted query vector is encrypted using the same encryption protocol used to encrypt the plurality of document vectors.

20. A method, comprising:
receiving an encrypted query vector, wherein a data owner generated the encrypted query vector from a query provided by a user, the query comprising a request to find at least one document from a plurality of documents having a similarity to a plaintext document included in the query;
the plurality of documents being stored at a third-party storage provider as a plurality of encrypted documents having corresponding encrypted vectors, wherein a data owner has, before storage at the third-party storage provider, encrypted (i) the plurality of documents and (ii) corresponding document vectors in which identifiers of text terms of the corresponding document are represented;
identifying at least one encrypted document having a determined similarity to the received at least one encrypted query vector, wherein the identifying comprises communicating between the third-party storage provider and at least another third-party storage provider, wherein the third-party storage provider and the at least another third-party storage provider do not collude;
the communicating allowing for (i) computation of a similarity between the received at least one encrypted query vector and at least one of the encrypted vectors and (ii) maintaining the encryption security of the plurality of encrypted documents and corresponding encrypted vectors from the third-party storage provider; and
returning, to the user, a plaintext version of the identified at least one encrypted document, wherein the at least one encrypted document has been decrypted by an agent other than an agent of the third-party storage provider.
